(19) United States
(12) Patent Application Publication
(10) Pub. No.: US 2024/0272450 A1
(43) Pub. Date: Aug. 15, 2024

(54) LENS UNIT AND LENS BARREL EQUIPPED WITH THE SAME

(71) Applicant: Panasonic Intellectual Property Management Co., Ltd., Osaka (JP)

(72) Inventor: Hiroyasu FUJINAKA, Osaka (JP)

(73) Assignee: Panasonic Intellectual Property Management Co., Ltd., Osaka (JP)

(21) Appl. No.: 18/405,551

(22) Filed: Jan. 5, 2024

(30) Foreign Application Priority Data
Feb. 14, 2023 (JP) 2023-020534

(51) Int. Cl. G02B 27/64; G02B 7/02

(52) U.S. Cl. CPC G02B 27/64; G02B 7/02

(57) ABSTRACT

A lens unit 20 includes a second lens group L2, an aperture unit 22, a frame body 21a, and a coil 23. The aperture unit 22 is disposed along the optical axis AX direction of the second lens group L2 with respect to the second lens group L2. The second lens group L2 is attached to the frame body 21a. The coil 23 is attached to the frame body 21a, is disposed so as to sandwich the aperture unit 22 between the coil 23 and the second lens group L2 in the optical axis AX direction, and is included in a linear motor 30 that drives the second lens group L2 and the frame body 21a back and forth in the optical axis AX direction.

### CROSS-REFERENCE TO RELATED APPLICATIONS

This application claims priority to Japanese Patent Application No. 2023-020534 filed on Feb. 14, 2023. The entire disclosure of Japanese Patent Application No. 2023-020534 is hereby incorporated herein by reference.

### BACKGROUND

### Technical Field

The present disclosure relates to a lens unit and a lens barrel including the same.

### Description of the Related Art

Recent years have seen the use of linear motors capable of high-speed response in order to move a lens frame body in a lens barrel in the optical axis direction.

For example, Patent Literature 1 discloses a lens barrel having a movable lens barrel that can be moved by a linear motor for a movable lens barrel, and a zoom lens that can be moved by a linear motor for a zoom lens, wherein a cylindrical yoke serving as an outer yoke piece, a guide shaft serving as an inner yoke piece, and magnets are common parts shared by these two motors.

### CITATION LIST

### Patent Literature

Patent Literature 1: JP-A H8-94905

### SUMMARY

### Problem to be Solved by the Disclosure

However, the following problem is encountered with the conventional lens barrel described above.

With the lens barrel disclosed in the above publication, the sharing of parts does reduce the required number of parts and assembly man-hours, but because the linear motor (coil, etc.) that drives the movable barrel is disposed on the outside in the radial direction of the movable barrel, a problem is that the lens barrel tends to become larger in size.

It is an object of the present disclosure to provide a lens unit with which the size of the lens barrel can be reduced, as well as a lens barrel equipped with this lens unit.

### Means for Solving Problem

The lens unit according to the present disclosure comprises a first optical element, a second optical element, a frame body, and a coil. The second optical element is disposed along the optical axis direction of the first optical element with respect to the first optical element. The first optical element is attached to the frame body. The coils are included in a linear motor that is attached to a frame body, is disposed so as to sandwich a second optical element between itself and first optical element in the optical axis direction, and drives the first optical element and the frame body back and forth in the optical axis direction.

### Effects

The lens unit disclosed herein allows for a reduction in the size of a lens barrel.

### BRIEF DESCRIPTION OF THE DRAWINGS

FIG. 1 is an overall oblique view of the configuration of a lens barrel including the lens unit according to an embodiment of the present disclosure;

FIG. 2 is an exploded oblique view of the lens barrel in FIG. 1;

FIG. 3 is an oblique view of the configuration of the lens unit included in the lens barrel in FIG. 2;

FIG. 4A is a front view of the lens unit in FIG. 3 as viewed from the subject side in the optical axis direction;

FIG. 4B is a cross-sectional view along the A-A line in FIG. 4A;

FIG. 5A is an oblique view of the yokes and magnets included in the linear motor that drives the second lens group frame unit in FIG. 3;

FIG. 5B is an exploded oblique view of the yokes and magnets in FIG. 5A;

FIG. 6 is an oblique view of a second lens group frame unit and a linear motor included in the lens unit in FIG. 3;

FIG. 7A is a front view of the second lens group frame unit and linear motor in FIG. 6 as viewed from the subject side in the optical axis direction;

FIG. 7B is a cross-sectional view along the B-B line in FIG. 7A;

FIG. 8 is an exploded oblique view showing the configuration of the second lens group frame unit included in FIG. 6;

FIG. 9 is an oblique view of the second lens group frame unit, lens, and linear motor included in the lens unit according to another embodiment of the present disclosure;

FIG. 10A is a front view of the lens unit in FIG. 9 as viewed from the subject side in the optical axis direction;

FIG. 10B is a cross-sectional view along the C-C line in FIG. 10A;

FIG. 11 is an oblique view of the second lens group frame unit, image stabilization unit, and linear motor included in the lens unit according to yet another embodiment of the present disclosure;

FIG. 12A is a front view of the lens unit in FIG. 11 as viewed from the subject side in the optical axis direction; and

FIG. 12B is a cross-sectional view along the D-D line in FIG. 12A.

### DETAILED DESCRIPTION OF THE EMBODIMENT

Embodiments will now be described in detail through reference to the drawings as needed. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

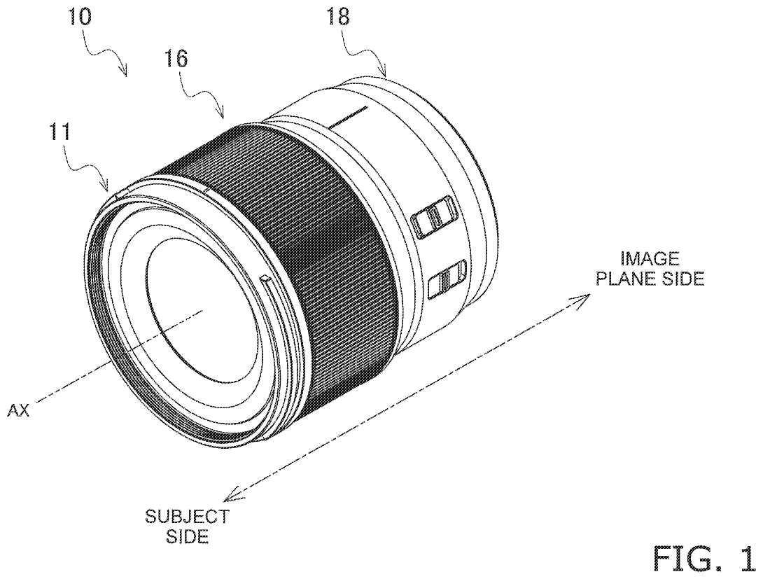

A lens unit 20, and a lens barrel 10 equipped with the same, according to an embodiment of the present disclosure will now be described through reference to FIGS. 1-8.

### (1) Configuration of Lens Barrel 10

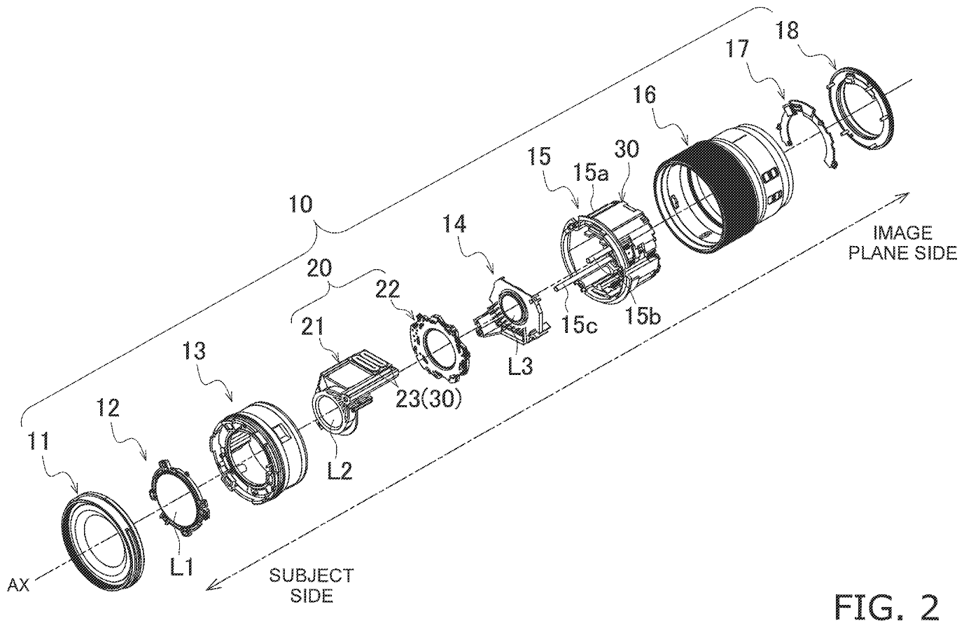

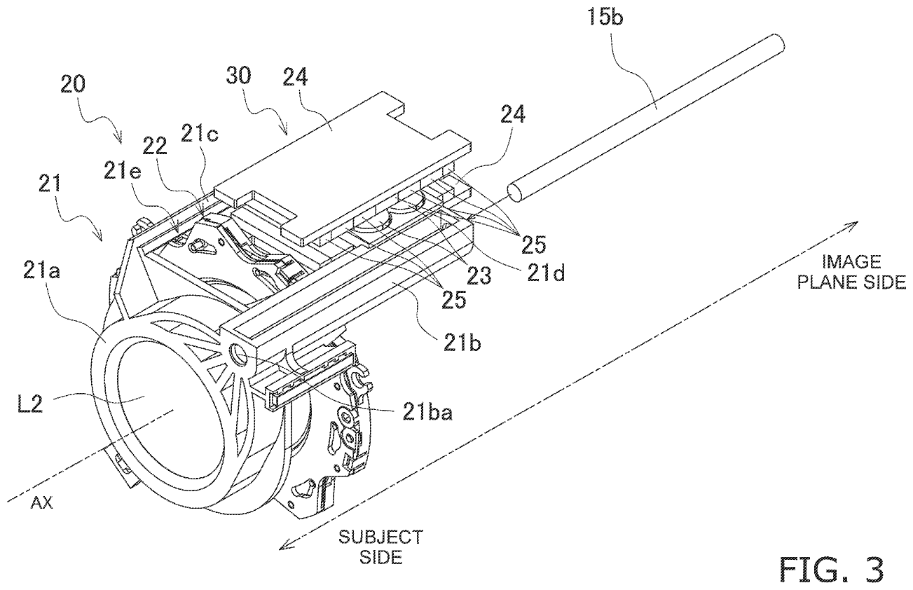

As shown in FIG. 1, the lens barrel 10 according to this embodiment has a substantially cylindrical shape, and is removably attached to a camera body (not shown). As shown in FIG. 2, the lens barrel 10 comprises a filter frame unit 11, a first lens group frame unit 12, a front fixed frame unit 13, a lens unit 20 (second lens group frame unit 21, aperture unit 22), a third lens group frame unit 14, a rear fixed frame unit 15, an exterior unit 16, a circuit board unit 17, a lens mount unit 18, and a linear motor 30 (see FIG. 3).

The filter frame unit 11 is a substantially annular member that constitutes part of the external appearance of the lens barrel 10, and as shown in FIG. 1, is attached to the subject-side surface of the front fixed frame unit 13 so as to cover the front fixed frame unit 13.

As shown in FIG. 2, the first lens group frame unit 12 is a substantially annular member that holds the first lens group L1. The first lens group frame unit 12 is attached to the substantially cylindrical front fixed frame unit 13 on the subject side in the optical axis AX direction. The first lens group frame unit 12 is also fixedly disposed inside the lens barrel 10.

As shown in FIG. 2, the front fixed frame unit 13 is a substantially cylindrical member, and the first lens group frame unit 12 is attached on the subject side in the optical axis AX direction. The front fixed frame unit 13 is also fixedly disposed inside the lens barrel 10.

The lens unit 20 is configured to include a second lens group frame unit 21 and an aperture unit 22, and is disposed on the inner peripheral surface side of the front fixed frame unit 13.

As shown in FIG. 2, the second lens group frame unit 21 holds a second lens group L2 (first optical element), and is driven back and forth in the optical axis AX direction by the linear motor 30 (discussed below).

As shown in FIG. 2, the aperture unit 22 (second optical element) is a substantially annular member that drives movable blades to vary the surface area of the aperture and adjust the amount of light passing through the lens portion of the lens barrel 10. The aperture unit 22 is also fixedly disposed on the inner peripheral surface side of the front fixed frame unit 13.

The detailed configuration of the lens unit 20, including the second lens group frame unit 21 and the aperture unit 22, will be described below.

As shown in FIG. 2, the third lens group frame unit 14 holds a third lens group L3, and is driven back and forth in the optical axis AX direction.

As shown in FIG. 2, the rear fixed frame unit 15 is a substantially cylindrical member, and the third lens group frame unit 14 is driven back and forth in the optical axis AX direction. The rear fixed frame unit 15 has a main body portion 15a, a guide shaft 15b (main shaft), and a guide shaft 15c.

The main body portion 15a is a substantially annular member, and the third lens group frame unit 14 is enclosed on the inner peripheral surface side of the main body portion 15a so as to be movable in the optical axis AX direction.

The guide shaft 15b (main shaft) is disposed on the inner peripheral surface side of the main body portion 15a, and is disposed in the optical axis AX direction. The guide shaft 15b is inserted into a main bearing portion 21b (see FIG. 3) of the second lens group frame unit 21, and guides the second lens group frame unit 21 in the optical axis AX direction.

The guide shaft 15c is disposed on the inner peripheral surface side of the main body portion 15a on the opposite side from the guide shaft 15b, and is disposed along the optical axis AX direction. The guide shaft 15c is inserted into the third lens group frame unit 14 and guides the third lens group frame unit 14 in the optical axis AX direction.

As shown in FIG. 2, the exterior unit 16 (housing portion) is a member having a substantially cylindrical shape that constitutes the exterior portion of the lens barrel 10, and encloses the above-mentioned front fixed frame unit 13, the lens units 20, the third lens group frame unit 14, and the rear fixed frame unit 15. An annular focus ring or the like is attached around the outer peripheral surface of the exterior unit 16 in a state of being rotatable in the circumferential direction.

As shown in FIG. 2, the circuit board unit 17 is attached to the end surface on the image plane side of the exterior unit 16.

As shown in FIG. 2, the lens mount unit 18 is a substantially annular member that is attached to the end on the image plane side of the rear fixed frame unit 15, and is replaceably mounted to the mounting portion of the camera body (not shown).

The linear motor 30 drives the second lens group L2 (first optical element) and a frame body 21a to move back and forth in the optical axis AX direction by passing current through coils 23 fixedly disposed on the frame body 21a and switching the direction of the current. As shown in FIGS. 2 and 3, the linear motor 30 has the coils 23, yokes 24, and a plurality of unipolar magnets 25.

The coils 23 are included in the linear motor 30 that is attached to the frame body 21a, is disposed so as to sandwich the aperture unit 22 between itself and the second lens group L2 in the optical axis AX direction, and drives the second lens group L2 and the frame body 21a back and forth in the optical axis AX direction.

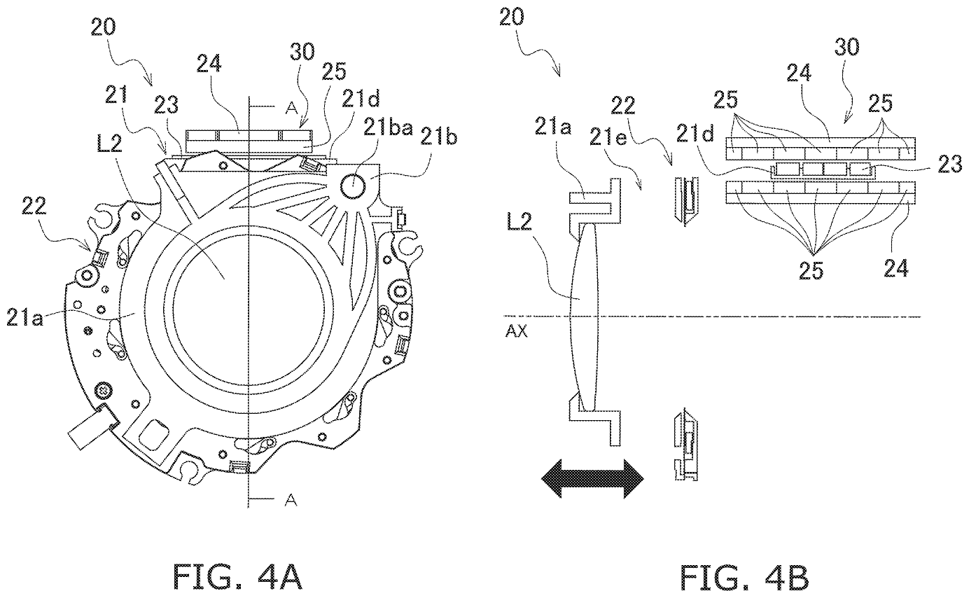

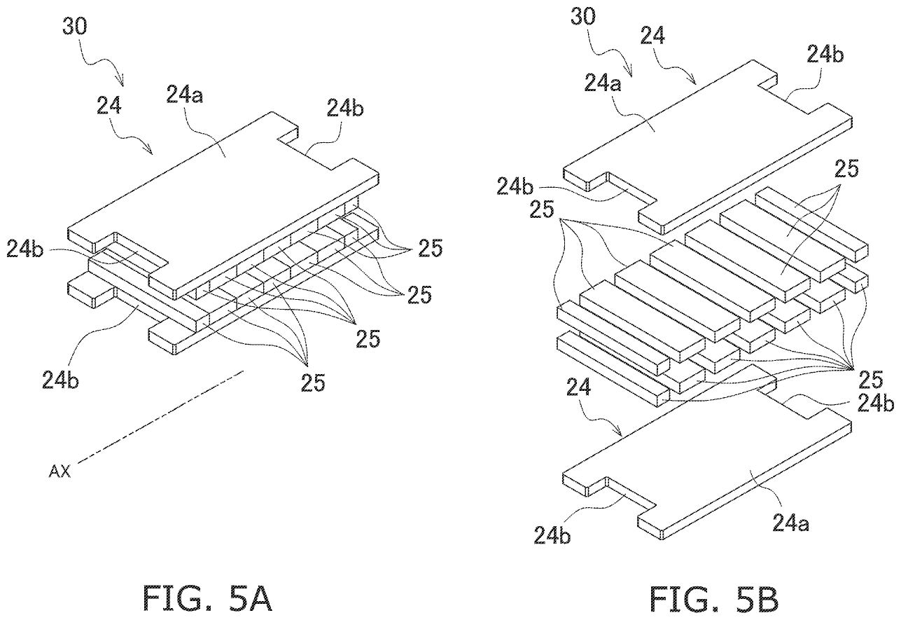

The yokes 24 are each a flat member that is made of iron and is formed by stamping, for example. As shown in FIGS. 4A and 4B, the two yokes 24 are disposed substantially parallel to each other, one above the other, in the upper part of the second lens group frame unit 21, and the coils 23 are disposed in between these. Also, as shown in FIGS. 5A and 5B, a plurality of magnets 25 are attached to the opposing surfaces of the two yokes 24.

Also, as shown in FIGS. 5A and 5B, the yokes 24 each have a main body portion 24a and recessed portions 24b.

The main body portion 24a has a substantially cuboid shape, and the recessed portions 24b are formed at both ends in the optical axis AX direction.

The recessed portions 24b are each a cutout portion formed in the approximate center of both end surfaces of the main body portion 24a in the optical axis AX direction, and is attached in a state in which part of the rear fixed frame unit 15 is engaged with the rear fixed frame unit 15.

This allows the yokes 24 to be easily positioned with respect to the rear fixed frame unit 15.

The magnets 25 are, for example, neodymium-based sintered magnets, are magnetized so that the surface in contact with the yoke 24 is the S pole and the surface on the opposite side is the N pole, and are fixed to the opposing surfaces of the two yokes 24 as shown in FIGS. 5A and 5B. The magnets 25 are disposed so that their lengthwise direction is perpendicular to the optical axis AX direction.

### (2) Configuration of Lens Unit 20

As shown in FIGS. 3 and 4A, the lens unit 20 in this embodiment comprises the second lens group frame unit 21, the aperture unit 22 (second optical element), and the coils 23 included in the linear motor 30.

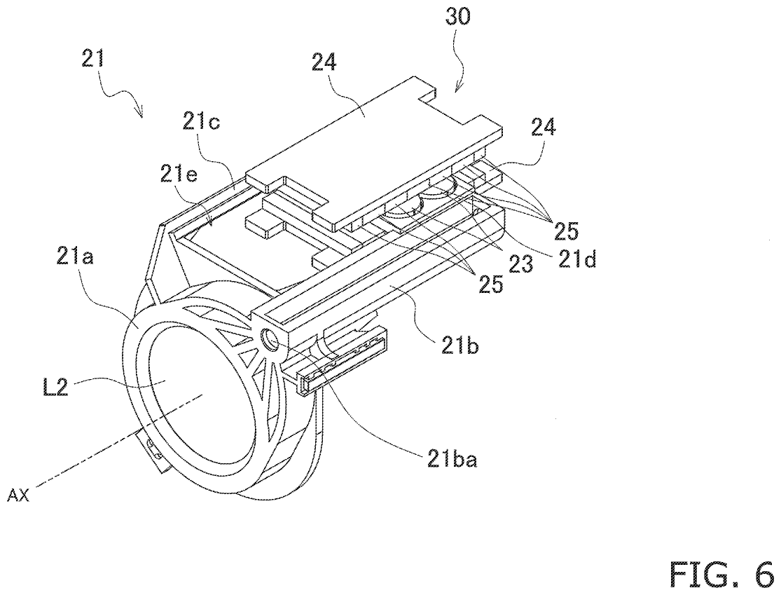

As shown in FIG. 6, the second lens group frame unit 21 has the frame body 21a that holds the second lens group L2 (first optical element), the main bearing portion 21b, a reinforced portion 21c, a coil mounting base 21d, and an opening 21e.

As shown in FIG. 6, the second lens group L2 (first optical element) is attached to the frame body 21a. As shown in FIG. 6, the frame body 21a has the main bearing portion 21b disposed in the optical axis AX direction, the reinforced portion 21c provided substantially parallel to the main bearing portion 21b, and an opening 21e formed between the main bearing portion 21b and the reinforced portion 21c.

As shown in FIG. 4B, the second lens group L2 is driven back and forth in the optical axis AX direction by the linear motor 30 while maintaining the positional relationship in which the aperture unit 22 is sandwiched between the second lens group L2 and the coils 23 included in the linear motor 30 in the optical axis AX direction. The second lens group L2 is fixed on the first end side (the subject side in the optical axis AX direction) of the main bearing portion 21b of the frame body 21a.

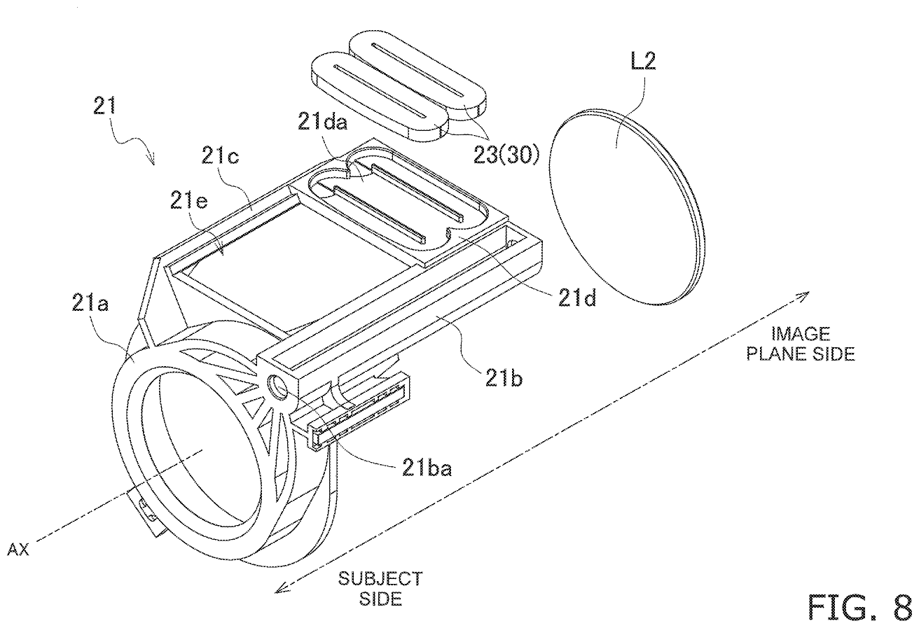

Also, the second lens group L2 is attached to the frame body 21a of the second lens group frame unit 21 from the image plane side in the optical axis AX direction (see FIG. 8).

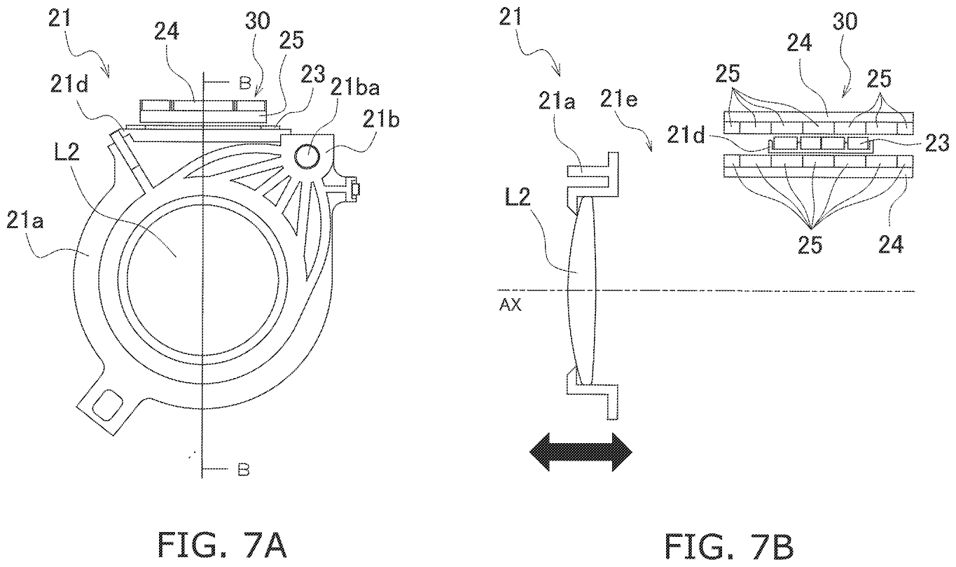

As shown in FIGS. 6 and 7A, the main bearing portion 21b has an insertion hole 21ba into which is inserted a guide shaft 15b that guides the frame body 21a in the optical axis AX direction. Consequently, as shown in FIG. 7B, the second lens group frame unit 21 is driven back and forth in the optical axis AX direction by the linear motor 30 in a state of being guided in the optical axis AX direction by the guide shaft 15b.

As shown in FIG. 8, the reinforced portion 21c is a flat portion disposed substantially parallel to the main bearing portion 21b, and links the upper part of the portion of the frame body 21a where the second lens group L2 is provided to the portion where the coils 23 are provided (the coil mounting base 21d) in the optical axis AX direction.

Consequently, in a configuration in which the coils 23 are disposed at a position away from the second lens group L2 in the optical axis AX direction, rigidity can be improved between the frame body 21a and the portion where the coils 23 are mounted (the coil mounting base 21d). This effectively suppresses vibration produced when the second lens group frame unit 21 is driven in the optical axis AX direction by the linear motor 30.

As shown in FIG. 8, the coil mounting base 21d is a base on which the two coils 23 are placed, and links the main bearing portion 21b and the reinforced portion 21c in a direction perpendicular to the optical axis AX direction. A concave coil holding portion 21da formed to match the shape of the two coils 23 is provided to the coil mounting base 21d.

As shown in FIG. 8, the coil holding portion 21da has a concave shape in which two ovals are connected in the short-side direction so that the two coils 23 fit inside. This makes it easy to position the two coils 23 disposed on the coil mounting base 21d.

As shown in FIG. 8, the opening 21e is formed between the frame body 21a and the coil mounting base 21d, and between the main bearing portion 21b and the reinforced portion 21c. That is, the opening 21e is a substantially square opening, and is formed so that its four sides are surrounded by the frame body 21a, the coil mounting base 21d, the main bearing portion 21b, and the reinforced portion 21c.

Part of the aperture unit 22 is disposed in a state of being inserted into the opening 21e (see FIGS. 3 and 4B). Consequently, the second lens group frame unit 21 is driven back and forth in the optical axis AX direction by the linear motor 30 with respect to the aperture unit 22 fixedly disposed inside the lens barrel 10.

As shown in FIG. 4B, the aperture unit 22 (second optical element) is disposed between the second lens group frame unit 21 and the third lens group frame unit 14 in the optical axis AX direction, and in the optical axis AX direction the second lens group L2. Furthermore, the aperture unit 22 is fixedly disposed inside the lens barrel 10. The second lens group frame unit 21 is driven back and forth in the optical axis AX direction with respect to the aperture unit 22 by the linear motor 30.

As shown in FIG. 4A, the aperture unit 22 is disposed at a position overlapping the coils 23 in the radial direction centered on the optical axis AX of the second lens group L2. That is, the aperture unit 22 is disposed at a position overlapping the coils 23 when viewed in the optical axis AX direction. Also, as shown in FIG. 4B, the aperture unit 22 is provided between the second lens group L2 and the yokes 24 included in the linear motor 30.

As shown in FIG. 8, the two coils 23 are fixed on the second end side (the image plane side in the optical axis AX direction) of the main bearing portion 21b of the frame body 21a, which is on the opposite side from the first end (the subject side in the optical axis AX direction). More specifically, the two coils 23 are disposed on the coil mounting base 21d provided on the image plane side in the optical axis AX direction with respect to the frame body 21a.

Consequently, when current is sent through the two coils 23, the coils 23 are subjected to Lorentz force from the magnets 25 disposed above and below, and are driven in the optical axis AX direction.

### Main Features

The lens unit 20 in this embodiment comprises the second lens group L2, the aperture unit 22, the frame body 21a, and the coils 23, as shown in FIG. 3, etc. The aperture unit 22 is disposed along the optical axis AX direction of the second lens group L2. The second lens group L2 is attached to the frame body 21a. The coils 23 are included in the linear motor 30 that is attached to the frame body 21a, is disposed so as to sandwich the aperture unit 22 between itself and the second lens group L2 in the optical axis AX direction, and drives the second lens group L2 and the frame body 21a back and forth in the optical axis AX direction.

As a result, the second lens group L2 and the frame body 21a, which are driven back and forth in the optical axis AX direction by the linear motor 30, and the coils 23 included in the linear motor 30 are not disposed adjacent to each other, and are instead disposed apart from each other in the optical axis AX direction.

Therefore, compared to a configuration in which the linear motor 30 (the coils 23, etc.) is disposed adjacent to the radially outer side of the second lens group L2, there is more latitude in the disposition of the linear motor 30 inside the lens barrel 10, and the lens barrel 10 can be made more compact.

### OTHER EMBODIMENTS

An embodiment of the present disclosure was described above, but the present disclosure is not limited to or by the above embodiment, and various changes are possible without departing from the gist of the disclosure.

### (A)

In the embodiment described above, an example was given in which the second lens group L2 was used as the first optical element, and the aperture unit 22 was used as the second optical element.

However, the present disclosure is not limited to this.

For example, the configuration may be such that the first optical element is some other optical element, such as an aperture unit or an image stabilization unit, rather than a lens.

Similarly, the configuration may be such that the second optical element is some other optical elements such as a lens, an image stabilization unit, etc., rather than an aperture unit.

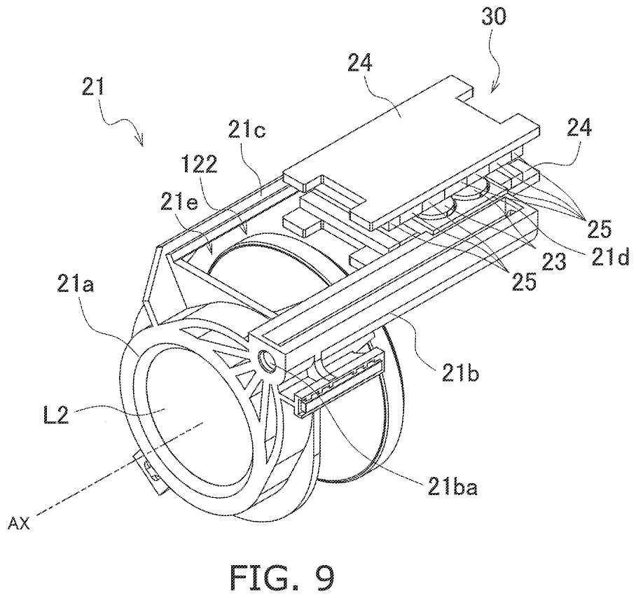

More specifically, as shown in FIG. 9, the configuration may be such that a lens 122 is provided as a second optical element instead of the aperture unit 22.

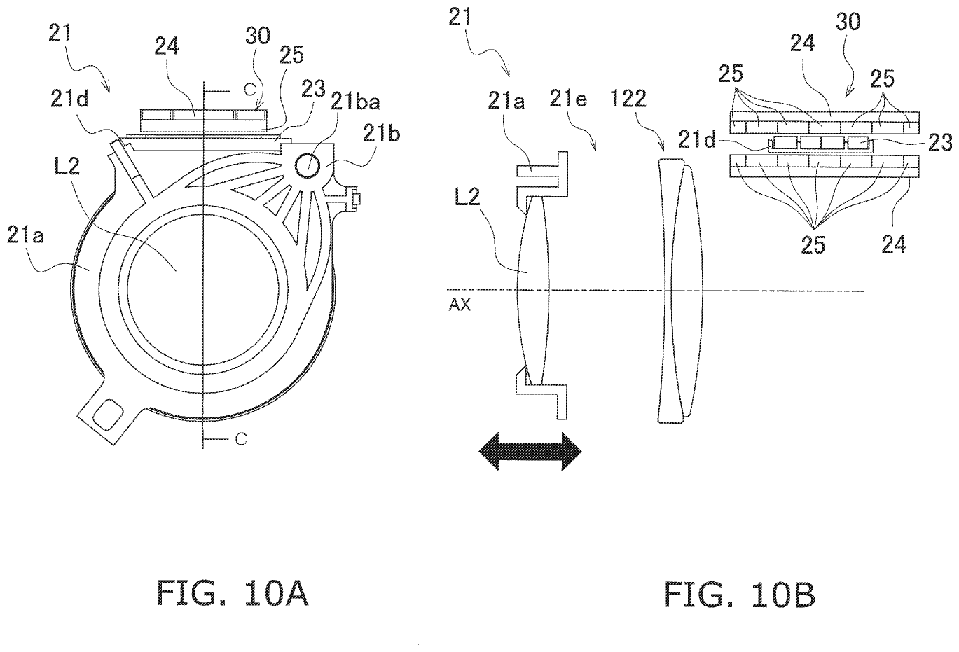

With this configuration, as shown in FIGS. 10A and 10B, the second lens group frame unit 21 is driven back and forth in the optical axis AX direction with respect to the lens 122 by the linear motor 30 in a state of being guided in the optical axis AX direction by the guide shaft 15b.

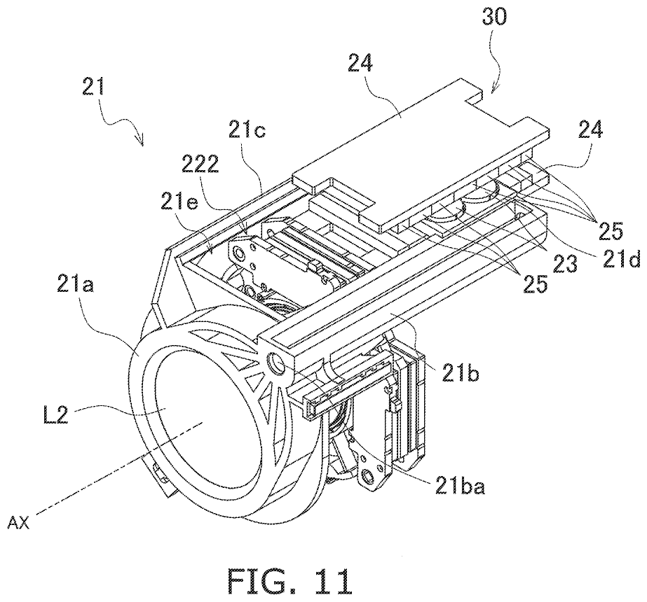

Also, as shown in FIG. 11, the configuration may such that an image stabilization unit 222 is provided as a second optical element instead of the aperture unit 22.

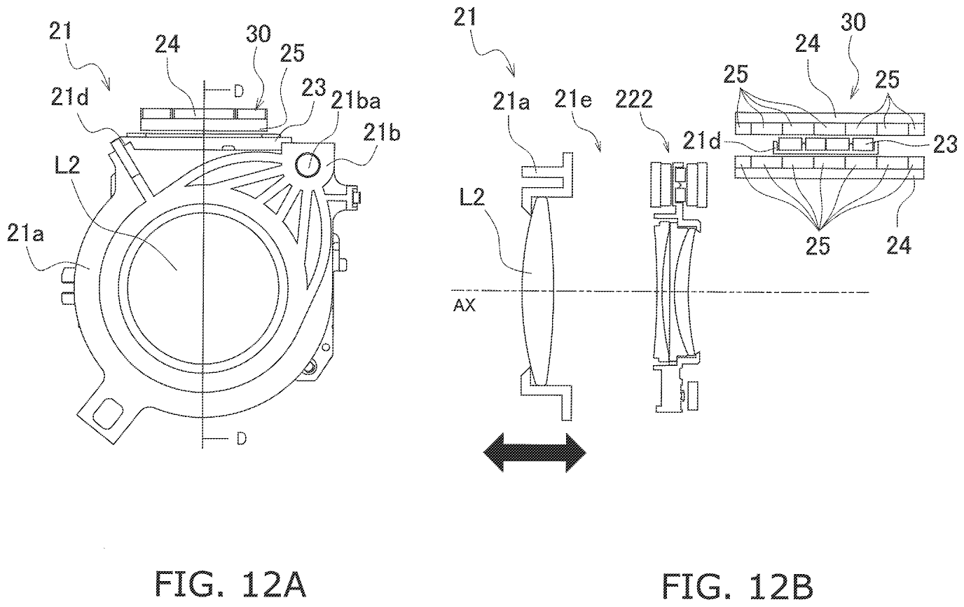

With this configuration, as shown in FIGS. 12A and 12B, the second lens group frame unit 21 is driven back and forth in the optical axis AX direction with respect to the image stabilization unit 222 by the linear motor 30 in a state of being guided in the optical axis AX direction by the guide shaft 15b.

### (B)

In the above embodiment, an example was given in which the aperture unit 22 (serving as a second optical element) was disposed in a state in which a part thereof was inserted into the opening 21e provided to the frame body 21a of the second lens group frame unit 21. However, the present disclosure is not limited to this.

For example, if the second optical element (aperture unit, etc.) is disposed between the first optical element (lens, etc.) and the coils included in the linear motor, a part thereof does not need to be inserted into an opening in the frame body.

### (C)

In the above embodiment, an example was given in which the linear motor 30 was configured using the substantially flat yokes 24. However, the present disclosure is not limited to this.

For example, the shape of the yokes included in the linear motor is not limited to being substantially flat, and may be some other shape.

### (D)

In the above embodiment, an example was given in which the frame body 21a of the second lens group frame unit 21 holding the second lens group L2 (serving as the first optical element) had the opening 21e formed between the main bearing portion 21b and the reinforced portion 21c, which were disposed substantially parallel to each other. However, the present disclosure is not limited to this.

For example, the configuration may be such that the frame body holding the first optical element has no opening.

### (E)

In the above embodiment, an example was given in which the two coils 23 included in the linear motor 30 were disposed on the coil mounting base 21d of the second lens group frame unit 21. However, the present disclosure is not limited to this.

For example, the number of coils included in a linear motor may be one, or may be three or more.

### (F)

In the above embodiment, an example was given in which the lens unit 20 of the present disclosure was mounted on the lens barrel 10, which was used as an interchangeable lens that could be attached to and detached from a camera body. However, the present disclosure is not limited to this.

For example, the configuration of the present disclosure may be applied to a lens unit included in a lens barrel that is non-removably attached to a camera body.

### INDUSTRIAL APPLICABILITY

The lens unit disclosed herein exhibits the effect that the size of a lens barrel can be reduced, and therefore can be widely applied to a variety of lens units that are included in a lens barrel.

### REFERENCE SIGNS LIST

10 lens barrel
11 filter frame unit
12 first lens group frame unit
13 front fixed frame unit
14 third lens group frame unit
15 rear fixed frame unit
15a main body portion
15b guide shaft (main shaft)
15c guide shaft
16 exterior unit (housing portion)
17 circuit board unit
18 lens mount unit
20 lens unit
21 second lens group frame unit
21a frame body
21b main bearing portion
21ba insertion hole
21c reinforced portion
21d coil mounting base
21da coil holding portion
21e opening
22 aperture unit (second optical element)
23 coil
24 yoke
24a main body portion
24b recessed portion
25 magnet
30 linear motor
122 lens (second optical element)
222 image stabilization unit (second optical element)
AX optical axis
L1 first lens group
L2 second lens group (first optical element)
L3 third lens group

1. A lens unit, comprising:
a first optical element;
a second optical element that is disposed along an optical axis direction of the first optical element with respect to the first optical element;
a frame body to which the first optical element is attached; and
a coil that is attached to the frame body, is disposed so as to sandwich the second optical element between the coil and the first optical element, and is included in a linear motor configured to drive the first optical element and the frame body back and forth in the optical axis direction.

2. The lens unit according to claim 1,
wherein the first optical element moves back and forth in the optical axis direction while maintaining a positional relationship in which the second optical element is sandwiched between the first optical element and the coil in the optical axis direction.

3. The lens unit according to claim 1,
wherein the second optical element is disposed at a position overlapping the coil when viewed in the optical axis direction.

4. The lens unit according to claim 1,
wherein the second optical element is provided between the first optical element and a yoke included in the linear motor.

5. The lens unit according to claim 1,
wherein the frame body has a main bearing portion that is disposed along the optical axis direction and into which is inserted a main shaft that guides the frame body in the optical axis direction,
the first optical element is fixed on a first end side of the main bearing portion of the frame body, and
the coil is fixed on a side of a second end that is on an opposite side from a first end of the main bearing portion of the frame body.

6. The lens unit according to claim 5,
wherein the frame body further has a reinforced portion that is provided substantially parallel to the main bearing portion and links a portion where the first optical element is provided and a portion where the coil is provided in the optical axis direction.

7. The lens unit according to claim 6,
wherein the frame body further has an opening formed between the main bearing portion and the reinforced portion.

8. The lens unit according to claim 7,
wherein the second optical element is disposed so that a portion thereof is inserted into the opening.

9. The lens unit according to claim 1,
wherein the second optical element is fixedly disposed.

10. The lens unit according to claim 1,
wherein the first optical element is either a lens, an aperture unit, or an image stabilization unit.

11. The lens unit according to claim 1,
wherein the second optical element is either an aperture unit, a lens, or an image stabilization unit.

12. A lens barrel, comprising:
the lens unit according to claim 1;
the linear motor configured to move the frame body back and forth in the optical axis direction; and
a substantially cylindrical housing portion that encompasses the lens unit and the linear motor.
